(19) United States
(12) Patent Application Publication
(10) Pub. No.: US 2018/0325159 A1
(43) Pub. Date: Nov. 15, 2018

(54) FRUIT AND VEGETABLE ROTATION MECHANISM AND PEELING DEVICE

(71) Applicant: ASTRA Co., LTD., Fukushima city (JP)

(72) Inventors: Takahiro KARINO, Fukushima City (JP); Hirotaka ICHIJO, Fukushima City (JP)

(21) Appl. No.: 15/977,856

(22) Filed: May 11, 2018

(30) Foreign Application Priority Data
May 15, 2017 (JP) 2017-096331

(51) Int. Cl. A23N 7/02

(52) U.S. Cl. CPC A23N 7/026; A47J 17/16

(57) ABSTRACT

In an embodiment of a fruit and vegetable holder 101, a plurality of fruit and vegetable pins 103 that pierce and hold a fruit or vegetable and are formed such as to be sharp are arranged on one end side, the other end side serves as a connecting section that is concentrically connected to a fruit and vegetable rotation shaft 105 that can be rotated by being driven by a fruit and vegetable rotation motor 107, such as to be capable of integrally rotating with the fruit and vegetable rotation shaft 105.

### BACKGROUND

### Technical Field

The present invention relates to a fruit and vegetable rotation mechanism and a peeling device including the fruit and vegetable rotation mechanism that are suitable for work such as peeling fruit and vegetables (fruit and vegetables that are provided as subjects to be peeled are hereafter referred to as “fruit and vegetables”), such as apples, oranges, kiwifruit, peaches, and turnips.

### Related Art

Since the past, in a process for peeling skin during processing treatment of fruit and vegetables, fruit and vegetable rotation mechanisms and peeling devices of various configurations have been used to enable the processing treatment to be quickly and easily performed.

For example, as a device for efficiently peeling the skin off of a persimmon during the production of dried persimmons, there is a peeling device that includes a fruit and vegetable rotation mechanism in which a persimmon is held by being pierced by a fixing pin that configures a holding section or by being attached to a suction section that configures the holding section by the suction section being placed in contact with a shoulder portion of the persimmon from which a stem and sepal area has been removed, and a motor rotatably drives a rotation shaft that is provided in the holding section. The peeling device is configured to peel the skin by a peeling blade being placed against a section of skin to be shaved off while being moved in the rotation-shaft direction of the fruit and vegetable rotation mechanism (refer to Patent Literature 1).

In addition, the inventors of the present invention have developed a peeling device that enables peeling of as many types of fruit and vegetables as possible by a single peeling device, does not leave unpeeled skin, and in which, when a fruit or vegetable that is deeply pierced by a fixing pin provided in a holding section that holds the fruit or vegetable is to be pulled off the fixing pin after completion of peeling, an eject lever is driven such that the peeled fruit or vegetable is shallowly pierced by the fixing pin, and work performed by a worker to pull the fruit or vegetable off the fixing pin can be easily, safely, and hygienically performed (refer to Patent Literature 2).

Patent Literature 1: Japanese Utility Model Application Publication No. 3180683

Patent Literature 2: Japanese Patent Laid-open Publication No. 2016-096744

### SUMMARY OF THE INVENTION

### Problem to be Solved by the Invention

As described above, an object of the peeling device disclosed in Patent Literature 2 is enable the work involved in pulling a fruit or vegetable off the fixing pin to be easily, safely, and hygienically performed, in a configuration in which the holding section for a fruit or vegetable in the fruit and vegetable rotation mechanism includes the fixing pin. The peeling device does not facilitate the work involved in deeply piercing the fruit or vegetable with the fixing pin to hold the fruit or vegetable to the holding section.

In addition, the shape of the fixing pin in the fruit and vegetable rotation mechanism and the configuration of the peeling blade (peeler blade) in the peeling device disclosed above are uniform. Therefore, the fruit and vegetable rotation mechanism and the peeling device are not necessarily capable of peeling various types of fruit and vegetables that differ in size, shape, softness/hardness of the flesh, presence/absence of a core, and the like. It has been found that, during driving for peeling, the hold on the fruit or vegetable may weaken, the fruit or vegetable may tilt, and peeling thickness may be insufficient.

The present invention has been achieved in light of such issues. An object of the present invention is to provide a fruit and vegetable rotation mechanism and a peeling device in which attachment and detachment of a fruit and vegetable holder in the fruit and vegetable rotation mechanism and a peeler in the peeling device are facilitated, a fruit or vegetable can be easily pierced by the fruit and vegetable holder with a small force and held with certainty during rotation in the fruit and vegetable rotation mechanism, and a fruit or vegetable can be peeled with certainty in the peeling device.

### Means for Solving Problem

To achieve the above-described object, a fruit and vegetable rotation mechanism of the present invention is a fruit and vegetable rotation mechanism in which a fruit and vegetable holder that supports a fruit or vegetable to be subjected to work is arranged such as to freely rotate by being driven by a fruit and vegetable rotation motor. The a fruit and vegetable rotation mechanism is characterized in that the fruit and vegetable holder is configured such that a plurality of fruit and vegetable pins that are formed such as to be sharp are arranged on one end side and the other end side serves as a connecting section that is concentrically connected to a fruit and vegetable rotation shaft that can be rotated by being driven by the fruit and vegetable rotation motor, such as to be capable of integrally rotating with the fruit and vegetable rotation shaft, and is formed such as to be freely attached to and detached from the fruit and vegetable rotation shaft.

As a result of the fruit and vegetable rotation mechanism configured in this manner, many types of fruit and vegetables are applicable through mounting of the fruit and vegetable holder that is selected based on differences in size, shape, softness/hardness of the flesh, presence/absence of a core, and the like in the fruit and vegetables to be subjected to work. The fruit and vegetables can be reliably held and rotated, and subjected to work such as removal of a stem and sepal area by a cutting blade or peeling by a peeler.

The connecting section is formed as a fitting section that is fitted onto the fruit and vegetable rotation shaft. Lock through holes are respectively formed in a direction orthogonal to an axial direction in the fruit and vegetable holder and the fruit and vegetable rotation shaft such that the lock through holes are able to concentrically pass through the fruit and vegetable holder and the fruit and vegetable rotation shaft in a state in which the connecting section of the fruit and vegetable holder and the fruit and vegetable rotation shaft are fitted together. Engagement between the fruit and vegetable holder and the fruit and vegetable rotation shaft is locked by a retaining member that has a pin that passes through each lock through hole and a circular arc-shaped clip that is capable of contact-pressing in a circumferential direction of the fruit and vegetable rotation shaft in a state in which the pin is continuously passed through the lock through hole of the fruit and vegetable holder and the lock through hole of the fruit and vegetable rotation shaft.

As a result of the fruit and vegetable rotation mechanism configured in this manner, the fruit and vegetable holder corresponding to the fruit or vegetable to be subjected to work can be concentrically connected to the fruit and vegetable rotation shaft 105 and integrally rotated therewith with certainty by a simple operation without use of a special tool.

The fruit and vegetable pins are round pins that are arranged on a virtual circumference of which a center point is a rotational axis of the fruit and vegetable holder.

As a result of the round pins that are arranged in this manner piercing the fruit or vegetable, the fruit or vegetable can be firmly held.

In addition, the fruit and vegetable pins are stepped round pins that are arranged on a virtual circumference of which a center point is a rotational axis of the fruit and vegetable holder, and in which a longitudinal-direction tip end side portion beyond a step section is formed such as to have a smaller diameter than a base end side portion.

As a result of the stepped round pins that are arranged in this manner piercing the fruit or vegetable, the fruit or vegetable can be firmly held. Furthermore, the base end side portions secure the arrangement of the stepped round pins, and the tip end side portions that are formed having a small diameter can easily pierce the fruit or vegetable with a small force. Therefore, the fruit and vegetable holder that is provided with the stepped round pins prominently exhibits its effectiveness in cases involving work on a fruit or vegetable with high flesh density (hard flesh), compared to the above-described fruit and vegetable holder provided with the round pins.

In addition, the fruit and vegetable pins are plate pins that are arranged on a virtual circumference of which a center point is a rotational axis of the fruit and vegetable holder, each plate pin having an L-shaped lateral cross-section and including a radiating surface that extends in a radiating manner from the rotational axis and a circumferential surface that extends in a rotation direction from an outer end side of the radiating surface.

As a result of the plate pins that are arranged in this manner piercing the fruit or vegetable, the fruit or vegetable can be rotated in a well-balanced manner and firmly held. Furthermore, during rotation, the radiating surfaces receive stress that acts on the fruit or vegetable as a result of the rotation. The circumferential surfaces prevent deformation of the radiating surfaces by carrying a portion of the stress applied to the radiating surfaces, and inhibits movement of the fruit or vegetable in an outer circumferential direction caused by rotational centrifugal force. Therefore, during driving of the peeling device, the hold on the fruit or vegetable does not weaken and the fruit or vegetable does not easily tilt. For example, the effect is prominently exhibited in cases involving work on a fruit or vegetable of which the flesh has become soft due to ripening or the like, as well as fruit and vegetables that inherently have soft flesh, such as kiwifruit.

Furthermore, the plurality of fruit and vegetable pins that are arranged on a virtual circumference of which a center point is a rotational axis of the fruit and vegetable holder are formed having a plurality of differing protrusion dimensions from a fruit and vegetable pin erection surface.

As a result of the plurality of differing protrusion dimensions of the fruit and vegetable pins from one end surface of the holder main body, the timings at which the fruit or vegetable comes into contact with the pointed tips (tip ends) of the fruit and vegetable pins can be made to differ when the fruit or vegetable is pierced by the fruit and vegetable holder and held. Consequently, because the force (force against frictional force) required to pierce the fruit or vegetable with the fruit and vegetable pins can be dispersed in time series, the fruit or vegetable can be held by the fruit and vegetable holder with a small force.

In addition, the fruit and vegetable holder subjects a fruit that has a central column to work and is provided with a fruit and vegetable center fixing pin that is inserted into/positioned in the central column on a rotational axis of the fruit and vegetable holder.

As a result of the fruit and vegetable center fixing pin being inserted into/positioned in the central column of a fruit, such as a citrus fruit, the fruit of which the space in the central column is filled by the fruit and vegetable center fixing pin can easily resist centrifugal force that accompanies the rotation of the fruit and vegetable holder in a manner similar to fruit and vegetables that are solid. Consequently, distortion of the outer shape of the fruit and tilting of the fruit can be suppressed.

Furthermore, the fruit and vegetable rotation mechanism subjects a stone fruit to work, and the plurality of fruit and vegetable pins provided on a virtual circumference of which a center point is a rotational axis of the fruit and vegetable holder are arranged such as to be capable of holding a stone of the stone fruit inside a surrounded space formed by the plurality of fruit and vegetable pins.

As a result of the stone of a stone fruit (such as a peach) being held in the surrounded space formed by the plurality of fruit and vegetable pins, the stone fruit can be rotated in a well-balanced manner and firmly held.

Moreover, a peeling device of the present invention includes a fruit and vegetable supporting section that is configured by the above-described fruit and vegetable rotation mechanism, and a peeler driving section that moves a peeler blade of a peeler main body that is supported by a peeler arm along an outer periphery of a fruit or vegetable that is supported by the fruit and vegetable holder in a state in which the peeler blade is pressed against the fruit or vegetable. In the peeler main body, swinging pivots that are formed such as to protrude from both ends in an extending direction of the peeler blade are arranged between arms of the peeler arm such as to be freely attached and detached.

As a result of the peeling device of the present invention configured in this manner, the fruit and vegetable holder and the peeler that are selected as appropriate in correspondence to the fruit or vegetable to be peeled can be attached and detached by a simple configuration. The fruit and vegetable holder that is provided in the fruit and vegetable supporting section facilitates piercing of the fruit or vegetable to be peeled by the fixing pins. Because the hold on the fruit or vegetable does not weaken and the fruit or vegetable does not easily tilt during driving of the peeling device, the fruit or vegetable to be peeled can be reliably peeled at a sufficient peeling thickness. Furthermore, maintenance, such as cleaning and disinfection, of the peeler that comes into direct contact with the fruit and vegetables is also facilitated.

As described above, as a result of the fruit and vegetable rotation mechanism of the present invention, the fruit and vegetable holder can be easily attached to and detached from the fruit and vegetable rotation shaft without the need of a special tool. Therefore, maintenance, such as cleaning and disinfection, is also facilitated. Furthermore, the fruit and vegetable pins in the fruit and vegetable holder of the fruit and vegetable rotation mechanism can pierce the fruit or vegetable with a small force, and hold the fruit or vegetable to the fruit and vegetable holder with certainty. Consequently, the hold on the fruit or vegetable does not weaken and the fruit or vegetable does not easily tilt during rotation of the fruit or vegetable.

In addition, because the hold on the fruit or vegetable does not weaken and the fruit or vegetable does not easily tilt during rotation of the fruit or vegetable, the peeling device that includes the fruit and vegetable rotation mechanism, together with the peeler that is suitable for the fruit or vegetable to be peeled, can reliably peel fruit and vegetables of various sizes and shapes. Adjustment and maintenance are also facilitated.

### BRIEF DESCRIPTION OF DRAWINGS

FIG. 1 is an overall perspective view of a configuration of a fruit and vegetable rotation mechanism and a peeling device including the fruit and vegetable rotation mechanism, according to an embodiment of the present invention.

FIG. 2 is a cross-sectional view of a main configuration of the peeling device in FIG. 1.

FIG. 3 is a perspective view of a retaining member used in the fruit and vegetable rotation mechanism of the peeling device in FIG. 1.

FIG. 4 is a diagram of another configuration of fruit and vegetable pins in a fruit and vegetable holder used in the fruit and vegetable rotation mechanism of the peeling device in FIG. 1.

FIG. 5A to FIG. 5H are diagrams of a fruit and vegetable holder in a fruit and vegetable rotation mechanism according to another embodiment of the present embodiment, in which FIG. 5A is a planar view, FIG. 5B is a left-side view, FIG. 5C is a front view, FIG. 5D is a right-side view, FIG. 5E is a rear view, FIG. 5F is a bottom view, FIG. 5G is a worm's eye view, and FIG. 5H is a bird's eye view.

FIG. 6A to FIG. 6H are diagrams of a fruit and vegetable holder in a fruit and vegetable rotation mechanism according to still another embodiment of the present embodiment, in which FIG. 6A is a planar view, FIG. 6B is a left-side view, FIG. 6C is a front view, FIG. 6D is a right-side view, FIG. 6E is a rear view, FIG. 6F is a bottom view, FIG. 6G is a worm's eye view, and FIG. 6H is a bird's eye view.

FIG. 7A to FIG. 7H are diagrams of a fruit and vegetable holder in a fruit and vegetable rotation mechanism according to still another embodiment of the present embodiment, in which FIG. 7A is a planar view, FIG. 7B is a left-side view, FIG. 7C is a front view, FIG. 7D is a right-side view, FIG. 7E is a rear view, FIG. 7F is a bottom view, FIG. 7G is a worm's eye view, and FIG. 7H is a bird's eye view.

FIG. 8 is an explanatory diagram of an attachment/detachment mechanism of a peeler in the peeling device of the present invention.

### EXPLANATIONS OF LETTERS OR NUMERALS

1 peeling device
2 device main body
3 main body case
4 main power supply switch
5 operation switch
20 carrying board
30 peeler driving section
31 peeler
31a peeler main body
32 peeler blade
33 peeler arm
33a, 33a arm
34, 34 hinge
35 arm base
36 peeler rib
37 urging member engaging section
38 shaft rack
39 peeler rotation motor
39a rotation shaft
40 gap
41 guide section
42 swinging pivot
43 peeler main body supporting section
45 knurled screw
46 notched opening
47 shaft locking section
48 notched recessing section
51 peeler shaft
52 motor pulley
53 peeler shaft pulley
54 tension belt
71 center shaft
71b base end flange
73 shaft axis pulley
74 tension belt
78 urging member (coil spring)
80 spring holder
81 positioning hole
82 positioning protruding section
85 knurled screw
100 fruit and vegetable supporting section
101 fruit and vegetable holder
102 holder main body
103 fruit and vegetable pin
104 top board
105 fruit and vegetable rotation shaft
106 fruit and vegetable pulley
107 fruit and vegetable rotation motor
107a rotation shaft
108 pulley motor
109 timing belt
110a (holder main body side) lock through hole
110b (fruit and vegetable rotation shaft side) lock through hole
111 insertion pin
112 clip
113 retaining member
11 oil seal
116 base
120 truncated conical section (step section)
121 fitting hole (connecting section)
124 radiating surface
125 circumferential surface
126 base plate
130 central-column fixing pin
149 engaging pin
150 adjustment input means

### DETAILED DESCRIPTION OF EMBODIMENTS

A fruit and vegetable rotation mechanism of the present invention will be described together with an embodiment of a peeling device of the present invention in which the fruit and vegetable rotation mechanism is mounted.

First, an overview of a configuration of the peeling device according to the present embodiment and operations thereof will be described.

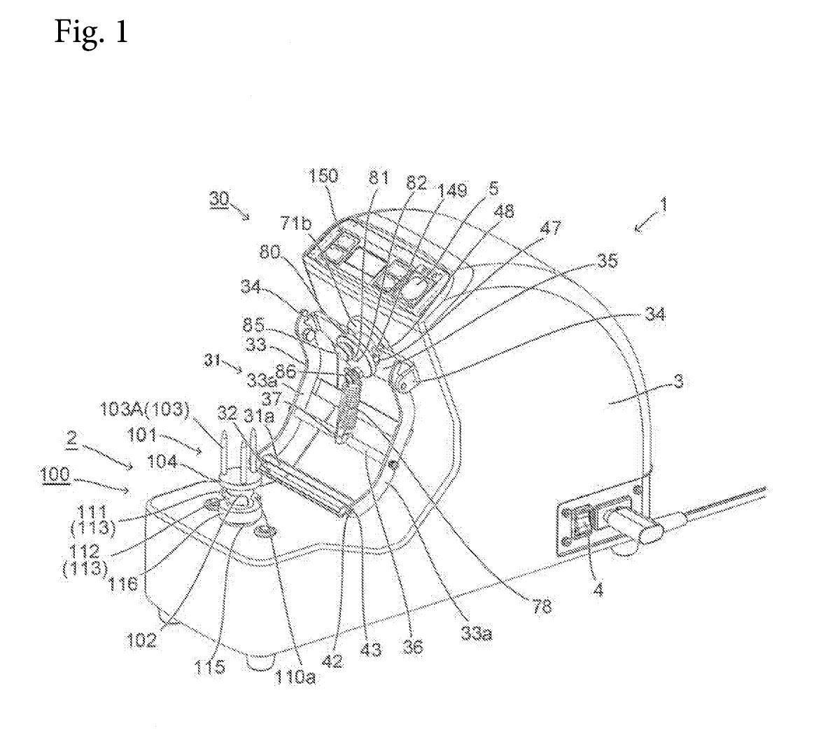

A peeling device 1 according to the present embodiment, shown in FIG. 1, includes a fruit and vegetable supporting section 100 and a peeler driving section 30. The fruit and vegetable supporting section 100 is configured by a fruit and vegetable rotation mechanism in which a fruit and vegetable holder 101 that supports a fruit or vegetable to be peeled in a peelable manner is arranged such as to be capable of rotating by being driven by a fruit and vegetable rotation motor 107. The peeler driving section 30 enables a peeler main body 31a that is supported by a peeler arm 33 of a peeler 31 to freely come into and out of contact with the fruit or vegetable that is held by the fruit and vegetable holder 101, and holds the peeler main body 31a such as to freely rotate along an outer periphery of the fruit or vegetable.

The peeler driving section 30 rotatably supports a peeler shaft 51 and a center shaft 71. The peeler shaft 51 is rotated by being driven by a peeler rotation motor 39 and moves the peeler main body 31a along the outer periphery of the fruit or vegetable that is supported by the fruit and vegetable holder 101. The center shaft 71 is arranged coaxially with the peeler shaft 51, and a coil spring 78 that serves as an urging member and of which one end is connected to the peeler 51 is provided such that the other end is connected to a position away from the peeler shaft 51 in a radial direction. The center shaft 71 is rotated by being driven by a shaft rotation motor (not shown).

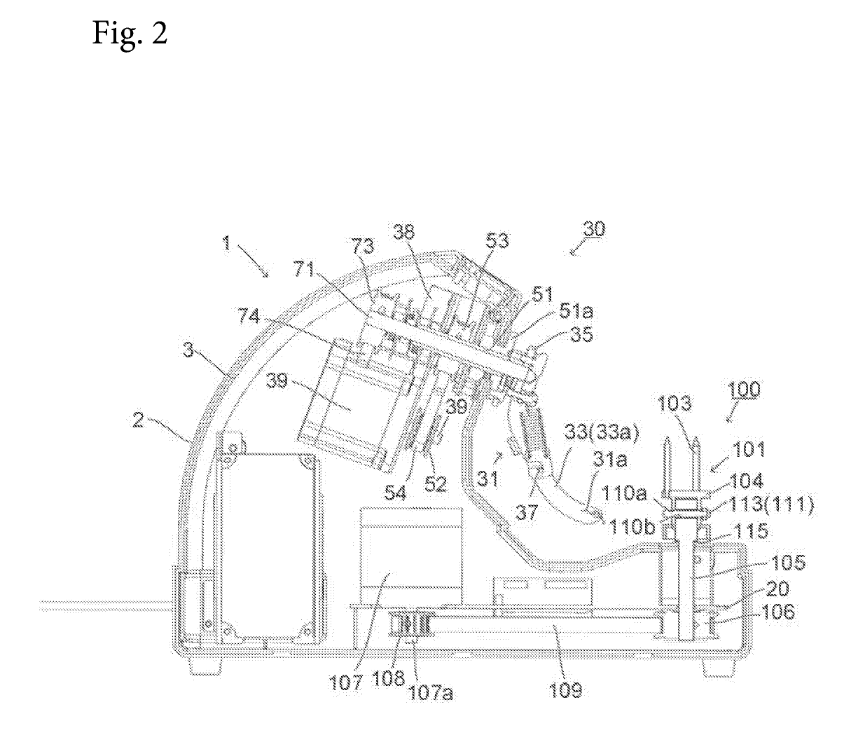

More specifically, as shown in FIG. 2, the peeler driving section 30 is provided on one end side in a longitudinal direction of a carrying board 20 that is in the form of a substantially rectangular thin plate and provided inside a device main body 2. The peeler driving section 30 supports, on a shaft rack 38, the hollow peeler shaft 51 that includes an inner hole and is capable of rotating by being driven by the peeler rotation motor 39. The peeler shaft 51 is capable of rotating as a result of driving force from the peeler rotation motor 39 being transmitted thereto, via a drive transmission system that is configured by a tension belt 54 that is looped between a motor pulley 52 provided in a rotation shaft 39a of the peeler rotation motor 39 that is placed on the shaft rack 38 that serves as a storage member and a peeler shaft pulley 53 provided in the peeler shaft 51.

A peeler shaft sensor plate (not shown) in which two slits that allow passage of detection light from an optical sensor (peeler shaft position detection sensor, not shown) are formed (at a 180-degree interval) on a circumference of a circular rotating body is provided in the peeler shaft 51, and is capable of detecting a rotation position (rotation amount) as a result of the peeler shaft position detection sensor detecting the detection light. The optical sensor is arranged on the shaft rack 38 and includes a light-emitting section and a light-receiving section for the detection light. A formation angle of the slits corresponds to a second angle, described hereafter.

In addition, an engaging pin (not shown) of a rotation lock member (not shown) is provided on the shaft rack 38 such as to freely swing in a direction coming into and out of contact with the peeler shaft 51 as a result of a rear end thereof being pivotally supported, and be urged in a peeler shaft direction at all times by a spring member that is stretched between a front end thereof and the shaft rack 38. In addition, a lock rotation body (not shown) of the rotation lock member that is composed of a substantially circular rotation body, and engages with the engaging pin and locks the rotation of the peeler shaft 51 during rotation of the peeler shaft 51 in one rotation direction is provided in the peeler shaft 51. The lock rotation body is arranged such that, when the engaging pin engages with a circumferential area of the lock rotation body and the rotation is locked, the peeler shaft 51 is positioned at a point of origin that serves as an initial angle for peeling.

Furthermore, the peeler driving section 30 supports, on the shaft rack 38, the center shaft 71 that is coaxially provided in an extending manner inside the shaft inner hole of the peeler shaft 51 such that one end thereof faces the fruit and vegetable supporting section 100 side and is capable of being rotated by the shaft rotation motor. The center shaft 71 is a rotation shaft for operating the coil spring 78 that serves as an urging member to place the peeler main body 31a in contact with the fruit or vegetable. The center shaft 71 is capable of rotating as a result of driving force from the shaft rotation motor being transmitted thereto, via a drive transmission system that is configured by a tension belt 74 that is looped between a motor pulley (not shown) provided in a drive shaft of the shaft rotation motor that is placed on the shaft rack 38 and a shaft axis pulley 73 provided in the center shaft 71.

A shaft axis sensor plate (not shown) in which a single slit that allows passage of detection light from an optical sensor (shaft position detection sensor, not shown) is formed on a circumference of a circular rotating body is provided in the center shaft 71, and is capable of detecting a rotation position (rotation amount) as a result of the shaft position detection sensor detecting the detection light. The optical sensor is arranged on the shaft rack 38 and includes a light-emitting section and a light-receiving section for the detection light.

Here, in the peeler driving section 30 according to the present embodiment, the peeler 31 has a pair of arm-shaped arms 33a and 33a that support the peeler main body 31a including a peeler blade 32 such as to suspend the peeler main body 31a from tip end portions thereof in a manner enabling the peeler main body 31 to swing along the surface of the fruit or vegetable. The configuration by which the peeler main body 31a is supported by the pair of arms 33a and 33a will be described hereafter.

Base end portions of the pair of arms 33a and 33a are respectively attached in a freely swinging manner to a plate-shaped arm base 35 by a pair of hinges 34 and 34. A substantially semicircular shaft locking section 47 is formed in an end side center of the arm base 35 that extends substantially parallel to the peeler blade 32. Notched recessing sections 48 are formed in a total of three locations, that is, a deepest portion of the shaft locking section 47 and a pair of shallowest portions that are intersections with the end side. The arm base 35 is arranged such that the center shaft 71 is positioned in the shaft locking section 47, and the notched recessing sections 48 are respectively latched to corresponding engaging pins 149 that are formed in three locations on a base end flange 71b of the center shaft 71.

In addition, the peeler driving unit 30 has a circular disk-shaped spring holder 80 that is disposed in a tip end flange (not shown) of the center shaft 71. The spring holder 80 is fixed by a positioning hole 81 formed in the center thereof being fitted onto a positioning protruding section 82 formed in the center of the tip end flange of the center shaft 71, a screw hole formed near the circumferential portion of the spring holder 80 being aligned with a screw hole formed in the tip end flange of the center shaft 71, and a knurled screw 85 being used.

Furthermore, one end of the coil spring 78 that serves as an urging member to place the peeler blade 32 of the peeler 31 in contact with the fruit or vegetable is attached to the spring holder 80 by a screw 86.

The other end of the coil spring 78 is connected to an urging member engaging section 37 that is formed in a center portion of a peeler rib 36 that is provided between the pair of arms 33a and 33a of the peeler arm 33 such as to extend in parallel to the peeler blade 32. The coil spring 78 acts as an urging member of which tautness changes depending on the rotation of either of the center shaft 71 and the peeler shaft 51, or both, and that is capable of adjusting a state of contact/separation of the peeler main body 31a in relation to the fruit or vegetable.

Moreover, according to the present embodiment, the peeler driving section 30 supports the shaft rack 38 above the carrying board 20, such as to be oriented towards a center direction of the fruit or vegetable held by the fruit and vegetable holder, while an elevation angle of the peeler shaft 51 from a surface of the fruit and vegetable holder 101 orthogonal to an axial direction (surface parallel to the carrying board 20) ranges from 20 degrees to 25 degrees.

In addition, the fruit and vegetable supporting section 100 that is configured by the fruit and vegetable rotation mechanism and in which the fruit and vegetable holder 101 that supports a fruit or vegetable W in a peelable manner is arranged such as to freely rotate around an axial direction is provided on the other end side of the carrying board 20 in the longitudinal direction.

A fruit and vegetable pin 103 that pierces the fruit or vegetable is provided in the fruit and vegetable holder 101. The fruit and vegetable pin 103 will be described hereafter.

The fruit and vegetable holder 101 is provided in a freely rotating manner, such that an axis thereof vertically protrudes towards front and back surfaces of the carrying board 20, and is formed such as to be freely attached to and detached from a portion of a fruit and vegetable rotation shaft 105, described hereafter, that vertically protrudes towards the front surface of the carrying board 20. A single fruit and vegetable pulley 106 that includes a configuration to restrict rotation to only one direction (such as a one-way clutch mechanism) is provided in a portion of the fruit and vegetable rotation shaft 105 that vertically protrudes from the back surface of the carrying board 20.

In addition, the fruit and vegetable supporting section 100 includes the fruit and vegetable rotation motor 107. According to the present embodiment, the fruit and vegetable rotation motor 107 is provided on a side opposite the placement position of the fruit and vegetable holder 101 in the longitudinal direction of the carrying board 20, that is, on the peeler driving unit 30 side of the carrying board 20. A rotation shaft 107a of the fruit and vegetable rotation motor 107 vertically protrudes from the back surface of the carrying board 20 and a single motor pulley 108 is provided therein. The fruit and vegetable supporting section 100 is configured such that the fruit and vegetable holder 101 that is connected to the fruit and vegetable rotation shaft 105 is rotated as a result of driving force in one direction from the fruit and vegetable rotation motor 107 being transmitted to the fruit and vegetable pulley 106, by a single timing belt 109 being looped over the motor pulley 108 and the fruit and vegetable pulley 106 on the back surface of the carrying board 20.

The peeling device 1 also includes a control unit (not shown) that determines the detection performed by each optical sensor, and controls driving (speed, rotation amount, synchronization, and the like) of each of the peeler rotation motor 39, the shaft rotation motor 70, and the fruit and vegetable rotation motor 107. According to the present embodiment, the control unit is capable of adjusting the driving of the fruit and vegetable rotation motor 107 and the driving of the peeler rotation motor 35 based on input signals from an adjustment input means 150.

Furthermore, according to the present embodiment, the carrying board 20 that carries the peeler driving section 30 and the fruit and vegetable supporting section 100, the control unit, electrical wiring, and the like are housed in a main body case 3, thereby configuring a device main body 1. A main power supply switch 4, an operation switch 5, a volume switch serving as the adjustment input means 150, a power supply outlet, and the like are arranged as appropriate in the main body case 3.

Here, the fruit and vegetable rotation mechanism according to the present embodiment will be described in further detail.

The fruit and vegetable holder 101 that is arranged such as to freely rotate by being driven by the fruit and vegetable rotation motor 107 has a circular cylindrical holder main body 102. A plurality of fruit and vegetable pins 103 that are each formed such as to have a pointed tip to pierce and hold a fruit or vegetable is arranged on a circular disk-shaped top board 104 that is formed on one end side of the holder main body 102 and of which an upper surface serves as a fruit and vegetable pin erection surface. The fruit and vegetable holder 101 may be configured such that an upper surface of the holder main body 102 serves as the fruit and vegetable pin erection surface and the fruit and vegetable pins 103 are provided thereon.

The plurality of fruit and vegetable pins 103 in the fruit and vegetable holder 101 that is used in the fruit and vegetable rotation mechanism of the peeling device 1 shown in FIG. 1 and FIG. 2 are three round pins 103A that are arranged at an even interval (120 degrees) on a virtual circumference of which the center point is the rotational axis of the fruit and vegetable holder 101. According to the present embodiment, the “pin” used to hold the fruit and vegetable is formed such as to be sharp.

The other end portion of the holder main body 102 serves as a connecting section that is concentrically connected to the fruit and vegetable rotation shaft 105 that is capable of rotating by being driven by the fruit and vegetable rotation motor 107, such as to be capable of integrally rotating with the fruit and vegetable rotation shaft 105 and is formed such as to be freely attached and detached. According to the present embodiment, the connecting section is formed as a fitting hole 121 that is fitted onto the fruit and vegetable rotation shaft 105. The configuration of the connecting section is not limited to the configuration according to the present embodiment. For example, a fitting hole may be formed in the end surface of the fruit and vegetable rotation shaft 105. A fitting protruding section that is fitted into the fitting hole may be formed in the holder main body 102 of the fruit and vegetable holder 101.

Lock through holes 110a and 110b are respectively formed in a direction orthogonal to the axial direction in the cylindrical holder main body 102 and the fruit and vegetable rotation shaft 105. The lock through holes 110a and 110b concentrically pass through the holder main body 102 of the fruit and vegetable holder 101 and the fruit and vegetable rotation shaft 105 in a state in which the holder main body 102 and the fruit and vegetable rotation shaft 105 are fitted together.

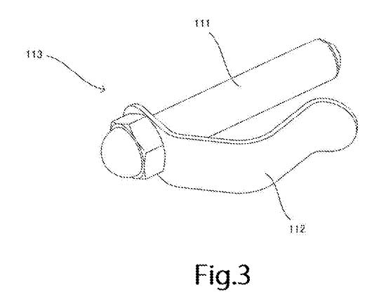

In addition, the holder main body 102 and the fruit and vegetable rotation shaft 105 are configured to be connected to each other such as to be locked with certainty by a retaining member 113 shown in FIG. 3 that includes an insertion pin 111 and a substantially circular arc-shaped clip 112 that is composed of an elastic material and is capable of contact-pressing in the circumferential direction of the fruit and vegetable rotation shaft 105, in a state in which the insertion pin 111 continuously passes through the lock through hole 110a of the fruit and vegetable holder 101 and the lock through hole 110b of the fruit and vegetable rotation shaft 105.

As a result of this configuration being provided, the fruit and vegetable holder 101 that is selected based on the fruit or vegetable to be subjected to work can be concentrically connected to the fruit and vegetable rotation shaft 105 and integrally rotated therewith with certainty by a simple operation without use of a special tool.

In addition, a base 116 that serves as a base portion of the fruit and vegetable rotation shaft 105 that protrudes from the main body case 3 when the fruit and vegetable holder 101 is connected to the fruit and vegetable rotation shaft 105, and covers a section in which an oil seal 115 is provided, is provided in the outer periphery on the other end side of the fruit and vegetable holder 101 according to the present embodiment. The base 116 is configured to prevent the fruit and vegetable rotation shaft 105 from becoming soiled or wet with juice from the fruit or vegetable.

The above-described round pins 103A in the fruit and vegetable holder 101 according to the present embodiment can appropriately hold various types of fruit and vegetables, such as apples, pears, persimmons, turnips, potatoes, and taro roots.

The fruit and vegetable holders 101 that have fruit and vegetable pins 103 that have configurations other than that of the round pins 103A and are used in other embodiments of the fruit and vegetable rotation mechanism suitable for holding fruit and vegetables that have other characteristics will be described below. Descriptions of constituent sections that are identical to those of the above-described fruit and vegetable holder 101 will be omitted.

<Fruit and vegetable holder 101—stepped round pin 103B>

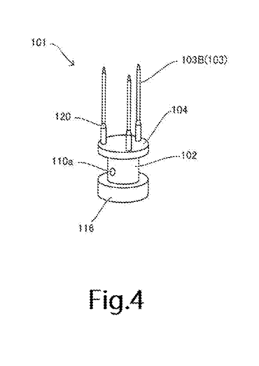

FIG. 4 is a perspective view of a configuration of another embodiment of the above-described fruit and vegetable holder 101.

In the fruit and vegetable holder 101, stepped round pins 103B in which a tip end side portion beyond a truncated conical section (referred to, hereafter, as a step section) 120 is formed such as to have a smaller diameter than a base end side portion are used as the fruit and vegetable pins 103. The stepped round pins 103B are arranged at an even interval on a virtual circumference of which the center point is the rotational axis of the fruit and vegetable holder 101.

The fruit and vegetable rotation mechanism that uses the fruit and vegetable holder 101 in which the stepped round pins 103B are provided is such that the tip end side portions of the stepped round pins 103B that are formed having a small diameter can easily pierce the fruit or vegetable, and the base end portion side is securely connected to the top board 104 of the fruit and vegetable holder 101.

The fruit and vegetable rotation mechanism that uses this fruit and vegetable holder 101 prominently exhibits its effectiveness in cases involving work on a fruit or vegetable with high flesh density (hard flesh), compared to the fruit and vegetable rotation mechanism that uses the fruit and vegetable holder 101 provided with the above-described round pins 103A.

<Fruit and Vegetable Holder 101—Stone Fruit Pin 103C>

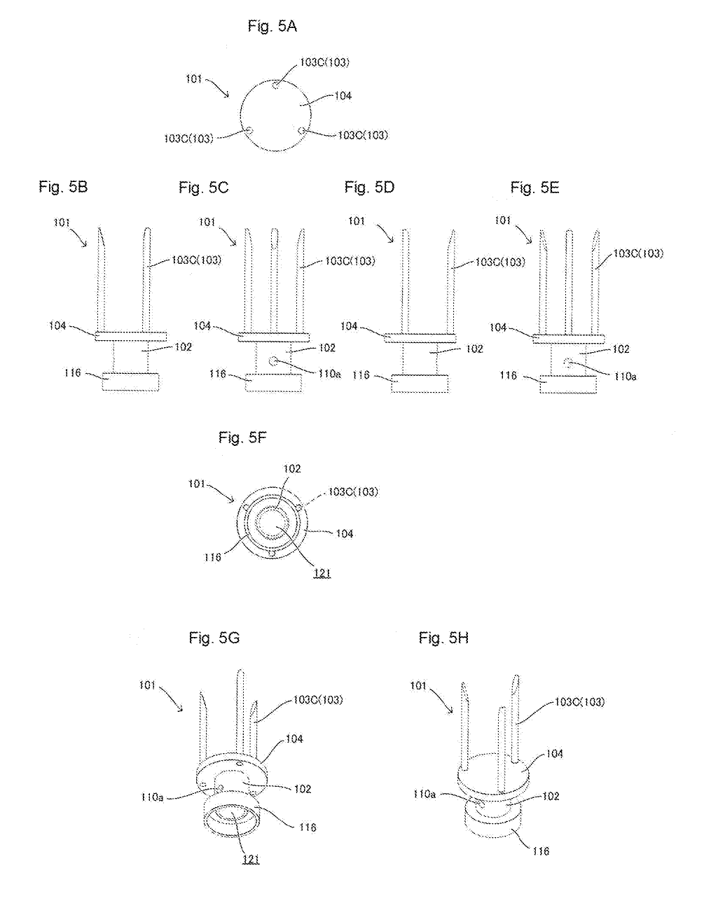

In cases in which the fruit or vegetable to be subjected to work is a stone fruit, such as a peach, in which a single large stone is present in the center of the fruit, a fruit and vegetable rotation mechanism that includes, as the fruit and vegetable holder 101, the fruit and vegetable holder 101 that is configured such that a plurality of fruit and vegetable pins (stone fruit pins) 103C that are provided on a virtual circumference of which the center point is the rotational axis of the fruit and vegetable holder 101 are arranged such as to be capable of holding the stone of the stone fruit inside a surrounded space formed by the plurality of fruit and vegetable pins 103C, as shown in FIG. 5A to FIG. 5H, is used.

FIG. 5A to FIG. 5H are perspective views of the configuration of the fruit and vegetable holder 101. As described above, the pins that are used to hold the fruit or vegetable are formed such as to be sharp. However, in the fruit and vegetable rotation mechanism for stone fruit, the tip of each fruit and vegetable pin 103C has a sharpened shape in which a cross-section that is oriented towards the rotational axis is formed, and is configured such that the cross-section acts as a guide surface that leads the stone of the stone fruit into the surrounded space.

As a result of the stone of the stone fruit (such as a peach) being held inside the surrounded space formed by the plurality of fruit and vegetable pins 103C, the stone fruit can be rotated in a well-balanced manner and firmly held.

<Fruit and Vegetable Holder 101—Plate Pin 103D>

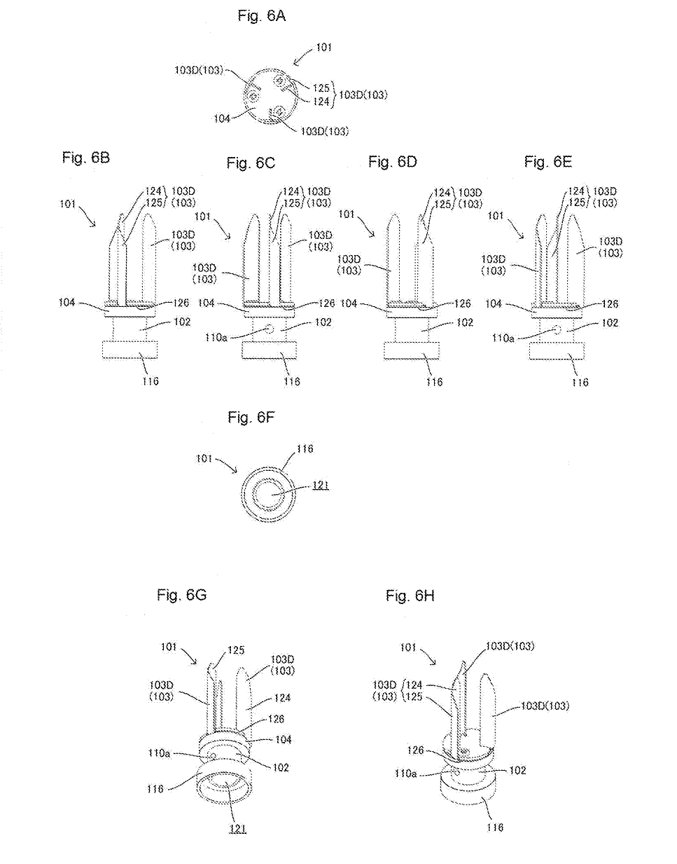

In addition, FIG. 6A to FIG. 6H are perspective views of a configuration according to still another embodiment of the above-described fruit and vegetable holder 101. The fruit and vegetable holder 101 uses plate pins 103D that each have an L-shaped lateral cross-section and include a radiating surface 124 that extends in a radiating manner from the rotational axis of the holder main body 102 and a circumferential surface 125 that extends in the rotation direction from an outer end side of the radiating surface 124, as the fruit and vegetable pins 103. The plate pins 103D are arranged at an even interval on a virtual circumference of which the center point is the rotational axis of the fruit and vegetable holder 101.

According to the present embodiment, the plate pins 103D configure a single-unit plate pin member that is formed such that lower ends of the radiating surfaces 124 and circumferential surfaces 125 are vertically connected to an upper surface of a base plate 126. The plate pins 103D are formed to serve as the fruit and vegetable holder 101 by being provided in predetermined positions on the holder main body 102 and fixed by screws.

As a result of the plate pins 103D that are configured and arranged in this manner piercing the fruit or vegetable, the fruit or vegetable can be rotated in a well-balanced manner and firmly held. In addition, during rotation, the radiating surfaces 124 receive stress that acts on the fruit or vegetable as a result of the rotation. The circumferential surfaces 125 prevent deformation of the radiating surfaces 124 by carrying a portion of the stress applied to the radiating surfaces 124, and inhibits movement of the fruit or vegetable in an outer circumferential direction caused by rotational centrifugal force. Therefore, during driving of the peeling device 1, the hold on the fruit or vegetable does not weaken and the fruit or vegetable does not easily tilt. For example, the effect is prominently exhibited in cases involving work on a fruit or vegetable of which the flesh has become soft due to ripening or the like, as well as fruit and vegetables that inherently have soft flesh, such as tomatoes and kiwifruit.

<Fruit and Vegetable Holder 101—Central-Column Fixing Pin 130 and Fruit and Vegetable Pin 103>

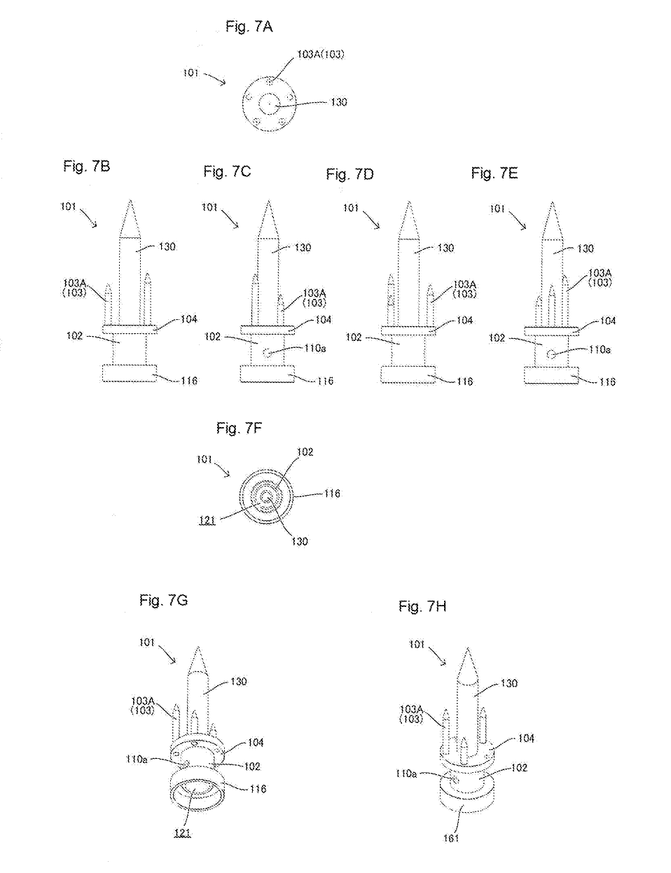

FIG. 7A to FIG. 7H are perspective views of a configuration according to still another embodiment of the above-described fruit and vegetable holder 101.

For example, in cases in which the fruit or vegetable to be subjected to work is a fruit or vegetable that has a central column, such as an orange or a grapefruit, a fruit and vegetable rotation mechanism that includes, as the fruit and vegetable holder 101, the fruit and vegetable holder 101 in which a central-column fixing pin 130 that is inserted into the central column is provided on the rotational axis of the circular cylindrical fruit and vegetable holder 101 is used.

The central-column fixing pin 130 is nevertheless a pin that is used to hold the fruit or vegetable. Therefore, the tip thereof is formed such as to be sharp.

In a manner similar to the fruit and vegetable holders 101 described up to this point, a plurality of fruit and vegetable pins 103 are provided on a virtual circumference on one end surface of the fruit and vegetable holder 101 of which the center point is the rotational axis. The plurality of fruit and vegetable pins 103 in the fruit and vegetable holder 101 shown in FIG. 7A to FIG. 7H are formed to have a plurality of differing protrusion dimensions by which the fruit and vegetable pins 103 protrude from the one end surface of the holder main body 102. In other words, a plurality of round pins 103A (three in FIG. 7A to FIG. 7H) that have differing height dimensions are provided.

As a result of the central-column fixing pin 130 being inserted into the central column of a fruit, such as a citrus fruit, and the fruit and vegetable pins 103A arranged in the outer periphery of the central-column fixing pin 130 holding the fruit in the foregoing manner, the fruit of which the space in the central column is filled by the central-column fixing pin 130 can resist centrifugal force that accompanies the rotation of the fruit and vegetable holder 101 in a manner similar to fruit and vegetables that do not have a central column. Consequently, distortion of the outer shape of the fruit and tilting of the fruit can be suppressed.

In addition, as a result of the plurality of differing protrusion dimensions of the fruit and vegetable pins 103 from the one end surface of the holder main body 102, the timings at which the fruit or vegetable comes into contact with the pointed tips of the fruit and vegetable pins 103 can be made to differ when the fruit or vegetable is pierced by the fruit and vegetable holder 101 and held. Consequently, because the force (force against frictional force) required to pierce the fruit or vegetable with the fruit and vegetable pins 103 can be dispersed in time series, the fruit or vegetable can be held by the fruit and vegetable holder 101 with a small force.

Next, the peeler 31 that is provided in the peeler driving section 30 of the peeling device 1 according to the present embodiment shown in FIG. 1 and FIG. 2 will be described.

As described above, the peeler 31 according to the present embodiment is supported such that swinging pivots 42 that are formed in a protruding manner on both ends in the extending direction of the peeler blade 32 are suspended in a freely attachable/detachable manner between the pair of arms 33a and 33a of the peeler arm 33.

The peeler 31 has a peeler main body 31a in which the peeler blade 32 and a guide section 41 are provided with a gap that extends in the longitudinal direction therebetween. The peeler 31 is suspended in a freely swinging manner, by the swinging pivots 42 formed on both ends in the longitudinal direction of the peeler main body 31a being supported by peeler main body supporting sections 43 that are formed in the arms 33a and 33a.

According to the present embodiment, near the peeler main body supporting section 43 of one arm 33a, a knurled screw 45 is screwed such that a tip end portion protrudes between the pair of arms 33a and 33a. The knurled screw 45 is configured to act as a rotation stopper that restricts a swinging angle of the peeler main body 31a as a result of the peeler main body 31a coming into contact with the tip end portion of the knurled screw 45.

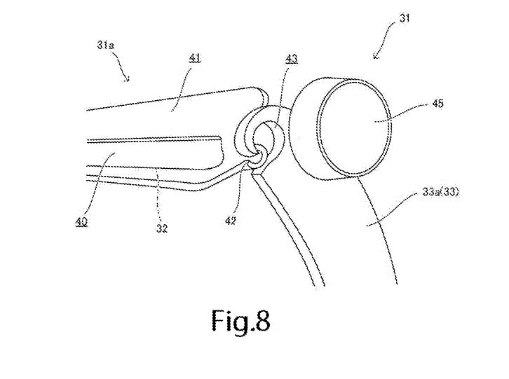

As shown in FIG. 8, the swinging pivot 42 is formed into a substantially tube-like shape that is bent to have a C-shaped cross-section. The peeler main body supporting section 43 that is formed in the arm 33a forms a support hole that pivotally supports the swinging pivot 43 such as to enable swinging. A notched opening 46 from which the swinging pivot 43 is inserted into and removed from the support hole is formed in the support hole of the peeler main body supporting section 43 that is formed in one arm 33a.

In a state in which the knurled screw 45 is loosened to an extent allowing the peeler main body 31a to rotate 360 degrees, the peeler 31a is rotated. A protruding portion of the arm 33a that configures the notched opening 46 is fitted into the recess of the C-shape of the swinging pivot 42, and one swinging pivot 42 is removed from the support hole of one peeler main body supporting section 43. Then, the other swinging pivot 42 is removed from the support hole of the other peeler main body supporting section 43. Through a process such as this, the peeler main body 31a can be detached from the arms 33a and 33a. The peeler 31 can be supported by the arms 33a and 33a by this process being performed in reverse. The peeler 31 that is selected based on the fruit or vegetable to be peeled can be attached and exchanged by a simple configuration.

The peeler 31 that includes the peeler main body 31a that has a publicly known peeler blade 32 that is a flat blade, a comb-tooth blade, or the like and suitable for peeling a fruit or vegetable to be peeled, and in which a width dimension (dimension in a direction orthogonal to the longitudinal direction) of the gap based on a peeling thickness of the fruit or vegetable to be peeled is secured is mounted in the above-described peeling device 1 according to the present embodiment.

In addition, the fruit and vegetable holder 101 based on the characteristics and size of the fruit or vegetable to be peeled is used as the fruit and vegetable holder 101 in the fruit and vegetable rotation mechanism. The peeler 31 of a size corresponding to the fruit and vegetable holder 101 is mounted in the peeling device 1. In the peeler arm 22 of the peeler 31 of each size, an opening angle at the hinge 34 sections is adjusted such that the peeler main body 31a does not come into contact with the fruit and vegetable pins 103 in the fruit and vegetable holder 101.

The fruit or vegetable held by the fruit and vegetable holder 101 maybe also be preprocessed fruit and vegetables. For example, in the case of oranges, grapefruit, lemons, and the like, a fruit apex portion from which the stem and sepal area has been cut off at a position where the flesh becomes visible may be pierced with the fruit and vegetable pins 103 of the fruit and vegetable holder 101.

Here, a peeling operation by the peeling device 1 that is provided with the above-described configuration will be described.

The fruit and vegetable holder 101 that is selected based on the type of fruit or vegetable to be peeled is concentrically connected to the fruit and vegetable rotation shaft 105 of the fruit and vegetable supporting section 100 such as to be capable of integrally rotating with the fruit and vegetable rotation shaft 105. In addition, the swinging pivots 42 that are formed in a protruding manner on both ends in the extending direction of the peeler blade 32 in the peeler main body 31a that is selected based on the type of the fruit or vegetable to be peeled are attached between the pair of arms 33a and 33a of the peeler arm 33.

Then, in a state in which the fruit or vegetable is held by the fruit and vegetable holder 101, the fruit and vegetable rotation motor 107 is rotated. In addition, the peeler driving section 30 is driven. The peeler blade 32 in the peeler main body 31a that is supported by the peeler arm 33 is moved along the outer periphery of the fruit or vegetable held by the fruit and vegetable holder 101, while being pressed against the fruit or vegetable. Peeling is thereby performed.

Specifically, the shaft rotation motor (not shown) is driven under the control of the control unit, the center shaft 71 is rotated in advance by a first angle, and a state of tension in the coil spring 78 is increased. As a result, the peeler main body 31a is pulled towards a pistil direction and placed in contact with the fruit or vegetable.

The first angle is an angle at which the peeler blade 32 of the peeler main body 31a is placed in contact with the fruit or vegetable, and further, pressure of the contact is adjusted. The first angle is a rotation angle from the point of origin. The point of origin is an angular position at which peeling is started and is not limited to a fixed angular position on the rotation trajectory of the peeler main body 31a. In addition, as described above, the first angle is a rotation-angle difference between the rotation angle of the peeler shaft 51 and the rotation angle of the center shaft 71.

Next, the peeler rotation motor 35 and the shaft rotation motor 70 are driven. The center shaft 71 and the peeler shaft 51 are synchronized and rotated by a second angle. Peeling is performed during this rotation of the peeler shaft 51. During this period, because the rotation-angle difference between the center shaft 71 and the peeler shaft 51 does not change, the state (pressure) in which the peeler main body 31a is in contact with the fruit or vegetable remains unchanged. The second angle refers to a movement angle on the rotation trajectory (circular arc) of the peeler main body 31a in the state in which the peeler main body 31a is in contact with the fruit or vegetable.

When the rotation over the second angle is completed, the shaft rotation motor 70 is driven and the center shaft 71 is rotated in reverse by the first angle in advance. As a result, contact with the fruit or vegetable by the peeler main body 31a is canceled. Subsequently, the peeler rotation motor 35 and the shaft rotation motor 70 are driven, and the center shaft 71 and the peeler shaft 51 are synchronized and rotated in reverse by the second angle, thereby being returned to the original position (point of origin). The rotation of the fruit and vegetable holder 101 is stopped.

Because the hold on the fruit or vegetable by the fruit and vegetable holder 101 does not weaken and the fruit or vegetable does not easily tilt during the peeling operation, the peeling device 1 according to the present embodiment is capable of reliably peeling the skin off the fruit or vegetable to be peeled at a sufficient peeling thickness.

The present invention is not limited to the above-described embodiments, and various modifications are possible to an extent that characteristics of the present invention are not compromised.

The fruit and vegetable rotation mechanism is not required to be assembled to another device, such as the peeling device. For example, the fruit and vegetable rotation mechanism may be configured as a single-unit fruit and vegetable rotation device that is used during work in which a fruit or vegetable is processed through use of a peeler or a cutter that is held by a worker.

The present application claims priority to Japanese Patent Application No. 2017-096331, filed May 15, 2017, the disclosure of which is incorporated herein by reference in its entirety including any and all particular combinations of the features disclosed therein.

We claim:

1. A fruit and vegetable rotation mechanism in which a fruit and vegetable holder that supports a fruit or vegetable to be subjected to work is arranged such as to freely rotate by being driven by a fruit and vegetable rotation motor, the fruit and vegetable rotation mechanism characterized in that:
the fruit and vegetable holder is configured such that a plurality of fruit and vegetable pins that are formed such as to be sharp are arranged on one end side and the other end side serves as a connecting section that is concentrically connected to a fruit and vegetable rotation shaft that can be rotated by being driven by the fruit and vegetable rotation motor, such as to be capable of integrally rotating with the fruit and vegetable rotation shaft, and is formed such as to be freely attached to and detached from the fruit and vegetable rotation shaft.

2. The fruit and vegetable rotation mechanism according to claim 1, characterized in that:
the connecting section is formed as a fitting section that is fitted onto the fruit and vegetable rotation shaft;
lock through holes are respectively formed in a direction orthogonal to an axial direction in the fruit and vegetable holder and the fruit and vegetable rotation shaft such that the lock through holes are able to concentrically pass through the fruit and vegetable holder and the fruit and vegetable rotation shaft in a state in which the connecting section of the fruit and vegetable holder and the fruit and vegetable rotation shaft are fitted together; and
engagement between the fruit and vegetable holder and the fruit and vegetable rotation shaft is locked by a retaining member that has a pin that passes through each lock through hole and a circular arc-shaped clip that is capable of contact-pressing in a circumferential direction of the fruit and vegetable rotation shaft in a state in which the pin is continuously passed through the lock through hole of the fruit and vegetable holder and the lock through hole of the fruit and vegetable rotation shaft.

3. The fruit and vegetable rotation mechanism according to claim 1, characterized in that:
the fruit and vegetable pins are round pins that are arranged on a virtual circumference of which a center point is a rotational axis of the fruit and vegetable holder.

4. The fruit and vegetable rotation mechanism according to claim 1, characterized in that:
the fruit and vegetable pins are stepped round pins that are arranged on a virtual circumference of which a center point is a rotational axis of the fruit and vegetable holder, and in which a longitudinal-direction tip end side portion beyond a step section is formed such as to have a smaller diameter than a base end side portion.

5. The fruit and vegetable rotation mechanism according to claim 1, characterized in that:
the fruit and vegetable pins are plate pins that are arranged on a virtual circumference of which a center point is a rotational axis of the fruit and vegetable holder, each plate pin having an L-shaped lateral cross-section and including a radiating surface that extends in a radiating manner from the rotational axis and a circumferential surface that extends in a rotation direction from an outer end side of the radiating surface.

6. The fruit and vegetable rotation mechanism according to claim 1, characterized in that:
the plurality of fruit and vegetable pins that are arranged on a virtual circumference of which a center point is a rotational axis of the fruit and vegetable holder are formed having a plurality of differing protrusion dimensions from a fruit and vegetable pin erection surface.

7. The fruit and vegetable rotation mechanism according to claim 1, characterized in that:
the fruit and vegetable holder subjects a fruit that has a central column to work and is provided with a fruit and vegetable center fixing pin that is inserted into the central column on a rotational axis of the fruit and vegetable holder.

8. The fruit and vegetable rotation mechanism according to claim 1, characterized in that:
the fruit and vegetable rotation mechanism subjects a stone fruit to work, and the plurality of fruit and vegetable pins provided on a virtual circumference of which a center point is a rotational axis of the fruit and vegetable holder are arranged such as to be capable of holding a stone of the stone fruit inside a surrounded space formed by the plurality of fruit and vegetable pins.

9. A peeling device comprising:
a fruit and vegetable supporting section that is configured by the fruit and vegetable rotation mechanism according to claim 1; and
a peeler driving section that moves a peeler blade of a peeler main body that is supported by a peeler arm along an outer periphery of a fruit or vegetable that is supported by the fruit and vegetable holder in a state in which the peeler blade is pressed against the fruit or vegetable, characterized in that
in the peeler main body, swinging pivots that are formed such as to protrude from both ends in an extending direction of the peeler blade are arranged between arms of the peeler arm such as to be freely attached and detached.

10. The fruit and vegetable rotation mechanism according to claim 2, characterized in that:
the fruit and vegetable pins are round pins that are arranged on a virtual circumference of which a center point is a rotational axis of the fruit and vegetable holder.

11. The fruit and vegetable rotation mechanism according to claim 2, characterized in that:
the fruit and vegetable pins are stepped round pins that are arranged on a virtual circumference of which a center point is a rotational axis of the fruit and vegetable holder, and in which a longitudinal-direction tip end side portion beyond a step section is formed such as to have a smaller diameter than a base end side portion.

12. The fruit and vegetable rotation mechanism according to claim 2, characterized in that:
the fruit and vegetable pins are plate pins that are arranged on a virtual circumference of which a center point is a rotational axis of the fruit and vegetable holder, each plate pin having an L-shaped lateral cross-section and including a radiating surface that extends in a radiating manner from the rotational axis and a circumferential surface that extends in a rotation direction from an outer end side of the radiating surface.

13. The fruit and vegetable rotation mechanism according to claim 2, characterized in that:
the plurality of fruit and vegetable pins that are arranged on a virtual circumference of which a center point is a rotational axis of the fruit and vegetable holder are formed having a plurality of differing protrusion dimensions from a fruit and vegetable pin erection surface.

14. The fruit and vegetable rotation mechanism according to claim 2, characterized in that:
the fruit and vegetable holder subjects a fruit that has a central column to work and is provided with a fruit and vegetable center fixing pin that is inserted into the central column on a rotational axis of the fruit and vegetable holder.

15. The fruit and vegetable rotation mechanism according to claim 1, characterized in that:
the fruit and vegetable rotation mechanism subjects a stone fruit to work, and the plurality of fruit and vegetable pins provided on a virtual circumference of which a center point is a rotational axis of the fruit and vegetable holder are arranged such as to be capable of holding a stone of the stone fruit inside a surrounded space formed by the plurality of fruit and vegetable pins.

16. A peeling device comprising:
a fruit and vegetable supporting section that is configured by the fruit and vegetable rotation mechanism according to claim 2; and
a peeler driving section that moves a peeler blade of a peeler main body that is supported by a peeler arm along an outer periphery of a fruit or vegetable that is supported by the fruit and vegetable holder in a state in which the peeler blade is pressed against the fruit or vegetable, characterized in that
in the peeler main body, swinging pivots that are formed such as to protrude from both ends in an extending direction of the peeler blade are arranged between arms of the peeler arm such as to be freely attached and detached.

17. The fruit and vegetable rotation mechanism according to claim 3, characterized in that:
the plurality of fruit and vegetable pins that are arranged on a virtual circumference of which a center point is a rotational axis of the fruit and vegetable holder are formed having a plurality of differing protrusion dimensions from a fruit and vegetable pin erection surface.

18. The fruit and vegetable rotation mechanism according to claim 3, characterized in that:
the fruit and vegetable holder subjects a fruit that has a central column to work and is provided with a fruit and vegetable center fixing pin that is inserted into the central column on a rotational axis of the fruit and vegetable holder.

19. The fruit and vegetable rotation mechanism according to claim 3, characterized in that:
the fruit and vegetable rotation mechanism subjects a stone fruit to work, and the plurality of fruit and vegetable pins provided on a virtual circumference of which a center point is a rotational axis of the fruit and vegetable holder are arranged such as to be capable of holding a stone of the stone fruit inside a surrounded space formed by the plurality of fruit and vegetable pins.

20. A peeling device comprising:
a fruit and vegetable supporting section that is configured by the fruit and vegetable rotation mechanism according to claim 3; and
a peeler driving section that moves a peeler blade of a peeler main body that is supported by a peeler arm along an outer periphery of a fruit or vegetable that is supported by the fruit and vegetable holder in a state in which the peeler blade is pressed against the fruit or vegetable, characterized in that
in the peeler main body, swinging pivots that are formed such as to protrude from both ends in an extending direction of the peeler blade are arranged between arms of the peeler arm such as to be freely attached and detached.
